(19) United States
(12) Patent Application Publication
(10) Pub. No.: US 2024/0183997 A1
(43) Pub. Date: Jun. 6, 2024

(54) Method for Determining at least One System State by Means of a Kalman Filter

(71) Applicant: Robert Bosch GmbH, Stuttgart (DE)

(72) Inventors: Alexander Metzger, Rottenacker (DE); Jens Strobel, Freiberg Am Neckar (DE); Mohammad Tourian, Stuttgart (DE)

(21) Appl. No.: 18/547,154

(22) PCT Filed: Jan. 27, 2022
(86) PCT No.: PCT/EP2022/051913

§ 371 Date: Aug. 19, 2023

(30) Foreign Application Priority Data
Feb. 24, 2021 (DE) 10 2021 104 425.1

(51) Int. Cl. G01S 19/39

(52) U.S. Cl. CPC G01S 19/393

(57) ABSTRACT

A method for determining at least one system state by way of a Kalman filter, wherein at least one measured value measured by at least one sensor of the system is supplied to the Kalman filter. The method includes (a) performing an estimation of the system state by way of the Kalman filter, a prediction step and a subsequent correction step being used to determine an estimation result and an associated item of information about the reliability of the estimation result, (b) determining a factor for correcting the item of information about the reliability of the estimation result, taking into account a discrepancy between a predicted estimation result associated with the estimation and a corrected estimation result associated with the estimation, and (c) correcting the item of information about the reliability of the estimation result using the factor determined in step b).

### DESCRIPTION

The invention relates to a method for determining at least one system state by means of a Kalman filter. Further specified are a computer program for performing the method, a machine-readable storage medium containing the computer program, and a locating device. The invention can in particular be used in the context of automated or autonomous driving.

### PRIOR ART

Using the Global Navigation Satellite System (GNSS), it is possible to make a geospatial position determination at any point on earth. A GNSS satellite orbits the earth and transmits encoded signals that the GNSS receiver uses to calculate the distance or separation between the receiver and the satellite by estimating the time difference between the time of signal reception and the transmission time. For example, the estimated distances to satellites can be converted by GNSS sensors into an estimate of the location of the receiver if enough satellites are tracked (typically more than 5). Currently, there are more than 130 GNSS satellites orbiting the earth, meaning that a maximum of 65 are typically visible on the local horizon.

What are referred to as Kalman filters have become established for use in the GNSS-based determination of navigation data, e.g., the position and speed of vehicles. Kalman filters are used to estimate system states on the basis of observations typically prone to error. In addition to the estimation result, Kalman filters also provide an associated item of information about the reliability of the estimation result. However, it could be observed that such information is often too optimistic and is usually output as a covariance matrix.

### DISCLOSURE OF THE INVENTION

Proposed here according to claim 1 is a method for determining at least one system state by means of a Kalman filter, wherein at least one measured value measured by at least one sensor of the system is supplied to the Kalman filter, said method comprising at least the following steps:
a) performing an estimation of the system state by means of the Kalman filter, a prediction step and a subsequent correction step being used to determine an estimation result and an associated item of information about the reliability of the estimation result;
b) determining a factor for correcting the item of information about the reliability of the estimation result, taking into account a discrepancy between a predicted estimation result associated with the estimation and a corrected estimation result associated with the estimation; and
c) correcting the item of information about the reliability of the estimation result using the factor determined in step b).

For example, steps a), b), and c) can be performed at least once and/or repeatedly in the sequence indicated in order to perform the method. Furthermore, steps a), b), and c), in particular steps a) and b), can be performed at least partially in parallel or simultaneously. In particular, the correction factor according to step b) can be determined at least in part during the estimation in step a), or it can be likewise estimated and/or estimated in combination. Further, the correction according to step c) can be performed at least in part during step a) or prior to the (final) output of the item of information about the reliability of the estimation result.

The method is in particular used to provide an item of information about the reliability of the estimation result in a more realistic manner. Advantageously, the method can provide a representative variance or covariance matrix for the estimated position and/or speed within a locating device, e.g., a GNSS/INS locating sensor.

For example, the at least one system state can comprise at least one (ego) position and/or an (ego) speed. For example, the at least one sensor can be a GNSS sensor, an inertial sensor, and/or an environmental sensor, e.g., a RADAR sensor, LIDAR sensor, ultrasonic sensor, camera sensor, or the like. Moreover, steering angle sensors and/or wheel speed sensors can be used. The method can be performed in and/or for a vehicle. For example, the method can be performed by a locating device of a vehicle. The at least one sensor can be arranged in or on the vehicle. The at least one system state can describe a state, in particular a navigational state (position, position, orientation) and/or a movement state (speed, acceleration) of the vehicle. For example, the vehicle can be an automobile, which is preferably configured for at least partially automated or autonomous driving operation.

The Kalman filter is typically defined by Kalman filter equations. The Kalman filter equations can be described in matrix notation as follows:

$${\hat{x}}_{k} = {F}_{k} {\hat{x}}_{k - 1} + {B}_{k} \vec{{u}_{k}} \qquad ( GL1 )$$

$${P}_{k} = {F}_{k} {P}_{k - 1} {F}_{k}^{T} + {Q}_{k} \qquad ( GL2 )$$

$${\underbrace{\begin{matrix}{H}_{k} & {K}^{′}\end{matrix}}}_{K} = {\underbrace{{H}_{k} {P}_{k} {H}_{k}^{T}}}_{{\sum }_{0}} {( {\underbrace{{H}_{k} {P}_{k} {H}_{k}^{T}}}_{{\sum }_{0}} + {\underbrace{{R}_{k}}}_{{\sum }_{1}} )}^{- 1} \qquad ( GL3 )$$

$${\underbrace{{H}_{k} {\hat{x}}_{k}^{′}}}_{{μ}^{′}} = {\underbrace{{H}_{k} {\hat{x}}_{k}}}_{{μ}_{0}} + {\underbrace{{H}_{k} {K}^{′}}}_{K} ( {\underbrace{\vec{{z}_{k}}}}_{{μ}_{1}} - {\underbrace{{H}_{k} {\hat{x}}_{k}}}_{{μ}_{0}} ) \qquad ( GL4 )$$

$${\underbrace{{H}_{k} {P}_{k}^{′} {H}_{k}^{T}}}_{{\sum }^{′}} = {\underbrace{{H}_{k} {P}_{k} {H}_{k}^{T}}}_{{\sum }_{0}} - {\underbrace{{H}_{k} {K}^{′}}}_{K} {\underbrace{{H}_{k} {P}_{k} {H}_{k}^{T}}}_{{\sum }_{0}} \qquad ( GL5 )$$

The explicit equations having the mathematical symbols K, Σ′, Σ₀, Σ₁,μ′, μ₀, and μ₁, can in particular be used if a corresponding model variable (μ₀) with the same scale exists for each measured variable (μ₁) and/or (vice versa) a corresponding measured quantity having the same scaling exists for each model variable. If this is not the case, then Equations GL3 to GL5 can, e.g., use the mathematical symbols H, K′, P, R, \hat{x}, and z. For a numerical calculation, these equations can be expressed beforehand in explicit form, which can in particular be achieved by dividing H or H^{T} on both sides of the equation(s).

Equations GL1 and GL2 describe the iterative estimation process of the Kalman filter. In this case, \hat{x}ₖ or μ₀ describes the system state vector or a model value vector during chronological step k (estimation result of the prediction step); Fₖ describes the transition matrix propagating the system state from chronological step k-1 to chronological step k; Bₖ describes the dynamics of deterministic interference and projection on the system state; \vec{uₖ} describes the vector of the deterministic interference (e.g., known variables); Pₖ or Σ₀ describes the covariance matrix of the errors of \hat{x}ₖ (information about the reliability of the estimation result of the predicting step); and Qₖ describes the process noise or the covariance matrix of the process noise. Equations GL3 to GL5 describe the subsequent correction or fusion of the estimated model values using measured values acquired by means of sensors. In this case, Hₖ describes the observation matrix; K describes what is referred to as the Kalman gain;

Rₖ or Σ₁ describes the covariance matrix of the measurement noise; \vec{uₖ} or μ₁ describes the measured value vector comprising the new observations or measured values present during chronological step k; \hat{x}′ₖ describes the system state vector after application of the new observations (estimation result of the correction step); P′ₖ or Σ′ describes the covariance matrix of the errors of \hat{x}′ₖ (information about the reliability of the estimation result of the correction step).

In step a), an estimation of the system state is performed by means of the Kalman filter, a prediction step and (in each case) a subsequent correction step being used to determine an estimation result and an associated item of information about the reliability of the estimation result. The prediction step can be described by Equations GL1 and GL2. The correction step can be described by Equations GL3 to GL5. The system state during chronological step k is, by way of example, represented in this case by the mathematical symbol \hat{x}ₖ and generally represents the estimation result of the prediction step (Equation GL1). The covariance matrix comprising the mathematical symbols Pₖ usually represents the item information about the reliability of the estimation result of the prediction step (Equation GL2). The mathematical symbol K denotes what is referred to as the Kalman gain (Equation GL3). The mathematical symbol μ′ denotes the corrected system state, and thus typically the estimation result after the correction step (Equation GL4). This corrected estimation result generally represents the overall estimation result or one of the (two) outputs of the Kalman filter for chronological step k (Equation GL5). The mathematical symbol Σ′ denotes the corrected covariance matrix, and thus generally the item of information about the reliability of the estimation result of the correction step, or rather the overall estimation result for chronological step k. The corrected covariance matrix typically forms another or the second of the (two) outputs of the Kalman filter for chronological step k.

In step b), a factor for correcting the item of information about the reliability of the estimation result is determined taking into account a discrepancy between a predicted estimation result associated with the estimation and a corrected estimation result associated with the estimation. Generally, one factor or multiple factors can in this case be determined, each of which is determined taking into account a discrepancy between a predicted estimation result associated with the estimation and a corrected estimation result associated with the estimation. The factor (or one of the factors) can be used to correct the item of information about the reliability of the estimation result of the prediction step (mathematical symbol: Pₖ). Alternatively or cumulatively, the factor (or one of the factors) can be used to correct the item of information about the reliability of the estimation result of the correction step (mathematical symbol: Σ′). Preferably, the factor (or one of the factors) is at least used to correct the item of information about the reliability of the estimation result of the correction step (mathematical symbol: Σ′; or in Equation GL5, e.g., for correcting Equation GL5).

The discrepancy is determined between a predicted estimation result associated with the estimation (mathematical symbol: \hat{x}ₖ or μ₀) and a corrected estimation result associated with the estimation (mathematical symbol: \hat{x}′ₖ or μ′). In other words, the discrepancy between the prediction and the model value estimate is determined. Moreover, further discrepancies and/or correlations can be incorporated into the determination of the factor.

For example, the factor can be what is referred to as a cofactor to a matrix, in particular the covariance matrix in question. The cofactor in particular represents whether the covariance matrix selected is optimistic for observations, i.e., cofactor>1 or pessimistic, i.e., cofactor<1.

In step c), the item of information about the reliability of the estimation result is corrected using the factor determined in step b). In this case, the factor determined can, e.g., be denoted as σ².

In this case, the item of information about the reliability of the estimation result of the predicting step can, e.g., be corrected. In this context in particular, the covariance matrix for the prediction step can be corrected or scaled (mathematical symbol: P or Σ₀; Equation GL2). This can, e.g., be performed as follows in Equation GL2new:

σₖ²Pₖ=σₖ²FₖPₖ₋₁Fₖ^{T}+Qₖ (GL6new)

For example, alternatively or cumulatively, the item of information about the reliability of the estimation result of the correction step can in this case be corrected. In this context in particular, the covariance matrix for the correction step can be corrected or scaled (mathematical symbol: P′ or Σ′; Equation GL5). This can, e.g., be performed as follows in Equation GL5new:

$${\underbrace{{H}_{k} {P}_{k}^{′} {H}_{k}^{T}}}_{{\sum }^{′}} = {σ}_{k}^{2} ( {\underbrace{{H}_{k} {P}_{k} {H}_{k}^{T}}}_{{\sum }_{0}} - {\underbrace{{H}_{k} {K}^{′}}}_{K} {\underbrace{{H}_{k} {P}_{k} {H}_{k}^{T}}}_{{\sum }_{0}} ) \qquad ( GL7new )$$

In order to perform step c) in the aforementioned exemplary equation system using Kalman filter Equations GL1 to GL5 in particular, Equation GL2 can be replaced by Equation GL2new, and/or Equation GL5 can be replaced by Equation GL5new.

In this context, at least one correction of the item of information about the reliability of the estimation result of the correction step is preferably performed (even if the item of information about the reliability of the estimation result of the prediction step is not corrected). In other words, at least Equation GL5 is preferably replaced by Equation GL5new (even if equation GL2 is not replaced by Equation GL2new).

Alternatively or cumulatively, in order to perform step c), a corrected or final covariance matrix D or an overall covariance matrix D can be determined, in particular according to the following formula:

D=σ²Σ′

According to one advantageous configuration, it is proposed that the factor determined in step b) is a variance factor. The variance factor is in particular used to scale one or more variances or covariance matrices (e.g., Pₖ and/or Σ′) of the Kalman filter or the Kalman filter equations. Examples of this process were previously provided in the preceding paragraphs, in particular with respect to Equations GL2new and GL5new. For example, the (variance) factor can be what is referred to as a cofactor to a matrix, in particular the relevant covariance matrix. The cofactor in particular represents whether the covariance matrix selected is optimistic for observations, i.e., cofactor>1 or pessimistic, i.e., cofactor<1.

According to a further advantageous configuration, it is proposed that the determination of the factor for correcting the item of information about the reliability of the estimation result also takes place taking into account a discrepancy between at least one model value associated with the estimation (mathematical symbol: \hat{x}ₖor μ₀) and at least one measured value associated with the estimation (mathematical symbol: \hat{z}ₖ or μ₁).

According to a further advantageous configuration, it is proposed that the determination of the factor for correcting the item of information about the reliability of the estimation result also takes place taking into account a variance (mathematical symbol: v_{σ}_{²}) of the factor.

A corresponding variance (mathematical symbol: v_{σ}_{²}) of the factor can, e.g., be determined according to the following equation:

$${v}_{{σ}_{k}^{2}} = \frac{2 {( {\hat{σ}}_{k}^{2} )}^{2}}{n + 2 {( {σ}_{k - 1}^{2} )}^{2} / {v}_{{σ}_{k - 1}^{2}}}$$

The factor can preferably be based on Bayes' theorem (for Kalman filters). Described using other words, the factor is preferably determined using Bayes' theorem. Given that σ² is usually an unknown parameter, the prior distribution can be considered a normal gamma distribution. In a normally distributed likelihood function, a normal gamma prior is also conjugated and leads to a normal gamma distribution for the posterior. Said “prior” generally relates in this case to the results \hat{x}ₖ and Pₖ of the estimation process according to Equations GL1 and GL2. Said “likelihood function” generally relates in this case to the function according to Equations GL4 and GL5 of the correction step. Said “posterior” generally relates in this case to the results \hat{x}′ₖ and P′ₖ of the corrective step.

According to a particularly preferred embodiment, the factor (as a variance factor) can be determined or estimated, e.g., according to the following formula:

\hat{σ}ₖ²=(n+2(σₖ₋₁²)²/v_{σ}_{ₖ₋₁}²+2)⁻¹{2[(σₖ₋₁²)²/v_{σ}_{ₖ₋₁}²+1]σ_{k- 1}²+(\hat{x}′ₖ−\hat{x}ₖ)^{T}Pₖ⁻¹(\hat{x}′ₖ−\hat{x}ₖ)+(\hat{z}ₖ−Hₖ\hat{x}ₖ)^{T}Rₖ⁻¹(\hat{z}ₖ−Hₖ\hat{x}ₖ)}

In this context, σ₂ describes the factor, n describes the number of observations (measured values), k describes the respective chronological step, v describes the variance of the factor (determined, e.g., according to the formula stated above), x′ describes the state vector with the corrected estimation results (Equation GL4), x describes the state vector with the model values and/or model value vectors (determined in the prediction step or according to Equation GL1), P describes the covariance matrix for the predictive step (Equation GL2), z describes the observation vector or measured value vector, H describes the observation matrix (which maps the values of the system state to the observations), and R describes the covariance matrix of the measurement noise.

The item of information corrected according to step c) can, e.g., be used to determine at least one integrity parser about the integrity of a locating parameter. The at least one locating parameter can in this case be used to, e.g., locate a vehicle. For example, the at least one locating parameter can include an (ego) position and/or an (ego) speed of the vehicle. For example, the at least one integrity parameter can describe a confidence range or a confidence interval about the (true) value of the relevant locating parameter. Preferably, the integrity parasitic can be what is referred to as a protection level.

Proposed according to a further aspect is a computer program used for performing a method presented here. In other words, this aspect relatives in particular to a computer program (product) comprising instructions that, when the program is executed by a computer, prompt the latter computer to perform a method described here.

Proposed according to a further aspect is a machine-readable storage medium on which the computer program proposed here is stored or saved. Conventionally, the machine-readable storage medium is a computer-readable disk.

Proposed according to a further aspect is a locating device for a vehicle, wherein the locating device is configured to perform a method described here. The locating device can, for example, comprise a computer and/or control unit (controller) able to execute instructions for performing the method. The computer or control unit can, e.g., execute the specified computer program for this purpose. For example, the computer or control unit is able to access the specified storage medium in order to execute the computer program. For example, the locating device can be a movement and position sensor, in particular arranged in or on the vehicle.

The details, features, and advantageous configurations explained in connection with the method can also be correspondingly performed by the computer program, and/or the storage medium, and/or in the locating device presented here, and vice versa. In this respect, reference is made to the entirety of said explanations for a more specific characterization of the features.

The solution presented here and the technical environment thereof are explained in greater detail hereinafter with reference to the drawings. It should be noted that the invention is not intended to be limited by the embodiment examples disclosed. In particular, unless explicitly stated otherwise, it is also possible to extract partial aspects of the factual subject matter explained in the drawings and to combine them with other components and/or insights based on other drawings and/or the present description. Schematically shown are:

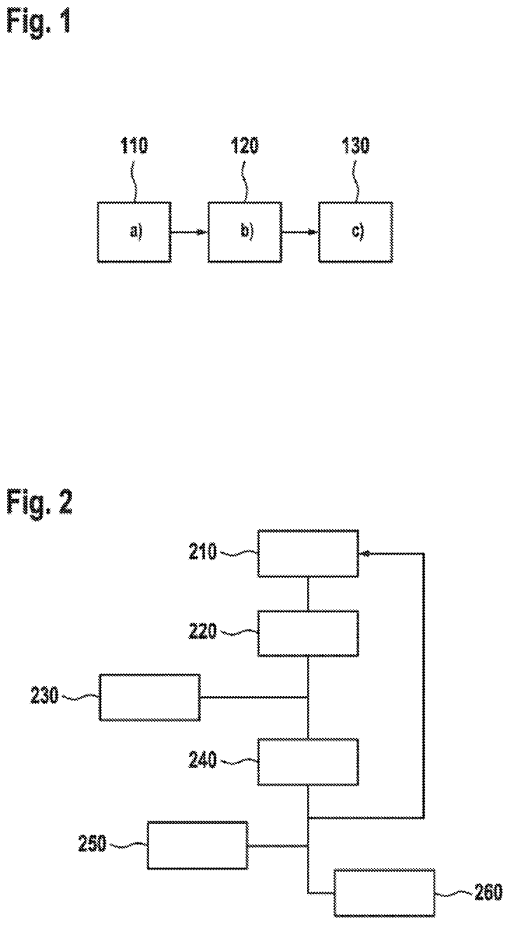

FIG. 1: an exemplary workflow of the method presented here, and

FIG. 2: a further exemplary workflow of the method presented here, and

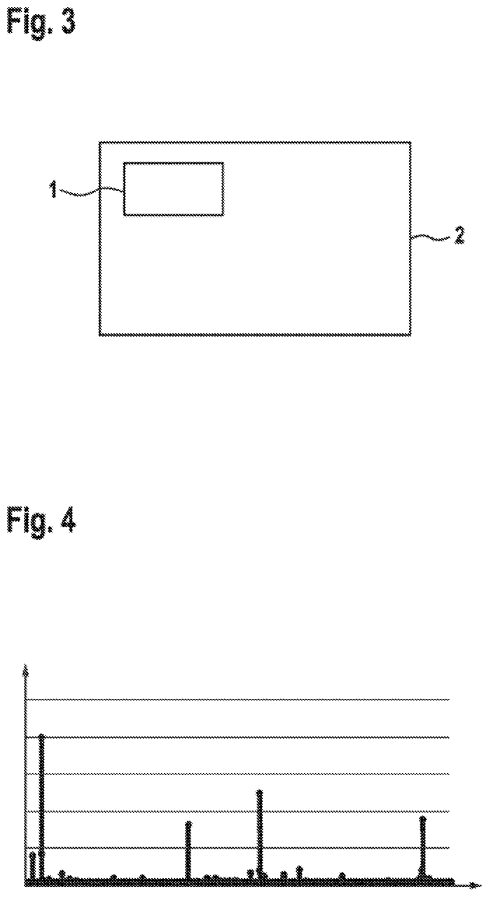

FIG. 3: an exemplary vehicle having a locating means described here, and

FIG. 4: exemplary measurement results for illustrating the method.

FIG. 1 schematically shows an exemplary workflow of the method presented here. The method is used for determining at least one system state by means of a Kalman filter, wherein at least one measured value measured by at least one sensor of the system is supplied to the Kalman filter. The sequence of steps a), b), and c) shown by blocks 110, 120, and 130 is an example and can, for example, be performed at least once in the sequence illustrated for performing the method.

In block 110, according to step a), an estimation of the system state is performed by means of the Kalman filter, wherein an estimation result and associated item of information about the reliability of the estimation result are determined using a prediction step and a subsequent correction step. In block 120, according to step b), a factor for correcting the item of information about the reliability of the estimation result is determined in consideration of a discrepancy between a predicted estimation result associated with the estimation and a corrected estimation result associated with the estimation. In block 130, according to step c), the item of information about the reliability of the estimation result is corrected using the factor determined in step b).

The factor determined in step b) can in this case be a variance factor. Further, determining the factor for correcting the item of information about the reliability of the estimation result can also be performed taking into consideration a discrepancy between at least one model value associated with the estimation and at least one measured value associated with the estimation. Determination of the factor for correcting the item of information about the reliability of the estimation result can also be performed by taking a variance of the factor into account.

Using the method, a particularly advantageous method for estimating a variance factor within the Kalman filter setup can be provided. The estimated variance factor can in this case be multiplied by the covariance matrix. Advantageously, with the aid of the proposed methodology, a covariance matrix as indicative as possible of the estimated position and speed can be output by the Kalman filter, which can be used as a basis for obtaining a representative uncertainty for (GNSS/INS based) locating sensors. A representative uncertainty in particular can contribute to compensating for the possible failure (estimated position vs. true position) within a certain high level of trust.

In the method, which is in particular used to obtain a representative variance for the estimated position, a variance factor based on Bayes' theorem for the estimated covariance matrix of the Kalman filter can be determined in a particularly advantageous manner. Described in other words, the factor is preferably determined using Bayes' theorem.

In Bayesian terms, the estimates in a Kalman filter can be obtained by multiplying the prior by the likelihood function. Given that the likelihood function is normally distributed by the Kalman filter, the prior is a conjugated prior resulting in posterior distribution within the same family. It can be demonstrated that the normal gamma distribution is also a conjugated prior leading to a normal gamma posterior. The covariance of the prior can therefore be considered as the multiplication of the unknown covariance matrix by the variance factor:

D(x)=σ²Σₓ

In particular, taking into account such a covariance matrix, it can be demonstrated that the square sigma or variance factor can be estimated in each step of the Kalman filter as follows:

\hat{σ}ₖ²=(n+2(σₖ₋₁²)²/v_{σ}_{ₖ₋₁}²+2)⁻¹{2[(σₖ₋₁²)²/v_{σ}_{ₖ₋₁}²+1]σ_{k- 1}²+(\hat{x}′ₖ−\hat{x}ₖ)^{T}Pₖ⁻¹(\hat{x}′ₖ−\hat{x}ₖ)+(\hat{z}ₖ−Hₖ\hat{x}ₖ)^{T}Rₖ⁻¹(\hat{z}ₖ−Hₖ\hat{x}ₖ)}

In this case, σ² describes the factor, n describes the number of observations, k describes the respective chronological step, v describes the variance of the factor, x′ describes the state vector with the corrected estimation results, x describes the state vector with the model values and/or model value vectors (determined in the prediction step or according to Equation GL1), P describes the covariance matrix for the prediction step (Equation GL2), z describes the observation vector or measured value vector, H describes the observation matrix (which maps the values of the system state to the observations), and R describes the covariance matrix of the measurement noise.

FIG. 2 schematically shows one example of a sequence of the method presented here. In block 210, a determination of the covariance matrix to the predicting step is performed. In block 220, addition of the process noise can in this case be performed (mathematical symbol: Q; see Equation GL2). Block 230 can furthermore be used to achieve initialization of the covariance matrix, if necessary. In block 240, the covariance matrix is corrected in the correction step (see Equation GL5). In block 250, the factor σ² is determined, e.g., according to the formula indicated above. In block 260, the covariance matrix corrected or scaled by the factor is output (see Equation GL5new).

FIG. 3 schematically illustrates an exemplary vehicle 2 having a locating means 1 described here. The locating means 1 is configured to perform a method described here.

FIG. 4 schematically illustrates exemplary measurement results for illustrating the method. The measurement results exhibit term amplitudes

(\hat{x}′ₖ−\hat{x}ₖ)^{T}Pₖ⁻¹(\hat{x}′ₖ−\hat{x}ₖ)

based on the above formula for the factor σ². This term can contribute in a particularly advantageous manner for considering a discrepancy between a predicted estimation result associated with the estimation and a corrected estimation result associated with the estimation (see step b) of the method).

On the one hand, it has been observed in simulations of an exemplary case, in which an 8-shaped trajectory was driven that, given a strongly non-linear trajectory, the specified term in the (variance) factor formula assumes a greater value. On the other hand, corresponding results (shown in FIG. 4) have also been observed during real-world driving tests. In particular, it has in this context been observed that the specified term increases along a curve.

A more advantageously realistic provision of the item of information about the reliability of the estimation result can be enabled as a result.

1. A method for determining at least one system state by way of a Kalman filter, wherein at least one measured value measured by at least one sensor of the system is supplied to the Kalman filter, said method comprising:
a) performing an estimation of the system state by way of the Kalman filter, a prediction step and a subsequent correction step being used to determine an estimation result and an associated item of information about the reliability of the estimation result;
b) determining a factor for correcting the item of information about the reliability of the estimation result, taking into account a discrepancy between a predicted estimation result associated with the estimation and a corrected estimation result associated with the estimation; and
c) correcting the item of information about the reliability of the estimation result using the factor determined in step b).

2. The method according to claim 1, wherein the factor determined in step b) is a variance factor.

3. The method according to claim 1, wherein determining the factor for correcting the item of information about the reliability of the estimation result is also performed by taking into account a discrepancy between at least one model value associated with the estimation and at least one measured value associated with the estimation.

4. The method according to claim 1, wherein determining the factor to correct the item of information about the reliability of the estimation result is also performed taking into account a variance of the factor.

5. A computer program for performing a method according to claim 1.

6. A machine-readable storage medium on which the computer program according to claim 5 is stored.

7. A locating device for a vehicle configured to perform a method according to claim 1.
